(19) United States
(12) Patent Application Publication
(10) Pub. No.: US 2024/0331419 A1
(43) Pub. Date: Oct. 3, 2024

(54) TRAINING METHOD OF OBJECT DETECTION MODEL, OBJECT DETECTION METHOD, APPARATUS AND DEVICE

(71) Applicant: Beijing Zitiao Network Technology Co., Ltd., Beijing (CN)

(72) Inventors: Kai YE, Beijing (CN); Yilei XIONG, Beijing (CN)

(21) Appl. No.: 18/620,283

(22) Filed: Mar. 28, 2024

(30) Foreign Application Priority Data
Mar. 31, 2023 (CN) 202310342221.6

(51) Int. Cl. G06V 20/70; G06V 10/74; G06V 10/764; G06V 10/77; G06V 10/774; G06V 10/776

(52) U.S. Cl. CPC G06V 20/70; G06V 10/761; G06V 10/764; G06V 10/7715; G06V 10/774; G06V 10/776

(57) ABSTRACT

The present disclosure provides a training method of an object detection model, an object detection method, an apparatus, and a device, and the method includes: acquiring an input image, and determining an object pseudo label of the input image based on an object detection model, wherein the input image is labeled with a real label; acquiring a multi-object detection result of the input image based on an auxiliary detection model; calculating a first loss according to the multi-object detection result of the input image and the real label of the input image, and calculating a second loss according to the multi-object detection result of the input image and the object pseudo label of the input image; and updating the auxiliary detection model according to the first loss and the second loss, and updating the object detection model based on the auxiliary detection model that has been updated.

### CROSS-REFERENCE TO RELATED APPLICATIONS

The present application claims priority to Chinese Patent Application No. 202310342221.6, filed on Mar. 31, 2023, the disclosure of which is incorporated herein by reference in the present application.

### TECHNICAL FIELD

The present disclosure relates to a training method, apparatus and device of an object detection model, and an object detection method, apparatus and device.

### BACKGROUND

Object detection is one of the important tasks in computer vision technology, and performing object detection on an image can identify the position and category of objects in the image. Multi-dataset object detection is to train one object detector on multiple datasets at the same time, and the label space of different datasets is different, so the object detector obtained by training can detect multiple types of objects in the image.

Before training the object detector with multiple datasets, it is necessary to acquire the labels of multiple datasets. However, the labels of multiple datasets need to be improved manually, which makes the labeling cost high.

### SUMMARY

In view of this, the present disclosure provides a training method, apparatus and device of an object detection model, as well as an object detection method, apparatus and device, which can train an object detection model with better performance, and perform multi-category object detection on an image based on the object detection model, to obtain more accurate multi-object detection results.

In order to solve the above problems, the technical solutions provided by the present disclosure are as follows.

In a first aspect, the present disclosure provides a training method of an object detection model, and the method includes:
acquiring an input image, and determining an object pseudo label of the input image based on an object detection model, in which the input image is labeled with a real label;
acquiring a multi-object detection result of the input image based on an auxiliary detection model;
calculating a first loss according to the multi-object detection result of the input image and the real label of the input image, and calculating a second loss according to the multi-object detection result of the input image and the object pseudo label of the input image;
updating the auxiliary detection model according to the first loss and the second loss, and updating the object detection model based on the auxiliary detection model that has been updated;
and continuously executing the acquiring the input image, determining the object pseudo label of the input image based on the object detection model, and subsequent steps until a preset condition is reached.

In a second aspect, the present disclosure provides an object detection method, which includes:
acquiring an image to be detected;
and acquiring a multi-object detection result of the image to be detected based on an object detection model,
in which the object detection model is acquired by the training method of an object detection model according to the first aspect.

In a third aspect, the present disclosure provides a training apparatus of an object detection model, and the apparatus includes:
a first acquisition unit, configured to acquire an input image and determine an object pseudo label of the input image based on an object detection model, in which the input image is labeled with a real label;
a second acquisition unit, configured to acquire a multi-object detection result of the input image based on an auxiliary detection model;
a calculation unit, configured to calculate a first loss according to the multi-object detection result of the input image and the real label of the input image, and calculate a second loss according to the multi-object detection result of the input image and the object pseudo label of the input image;
an updating unit, configured to update the auxiliary detection model according to the first loss and the second loss, and update the object detection model based on the auxiliary detection model that has been updated;
and an execution unit, configured to continuously execute the acquiring the input image, determining the object pseudo label of the input image based on the object detection model, and subsequent steps until a preset condition is reached.

In a fourth aspect, the present disclosure provides an object detection apparatus, which includes:
a first acquisition unit, configured to acquire an image to be detected;
and a second acquisition unit, configured to acquire a multi-object detection result of the image to be detected based on an object detection model,
in which the object detection model is acquired by the training method of an object detection model according to the first aspect.

In a fifth aspect, the present disclosure further provides an electronic device, which includes:
one or more processors;
and a storage apparatus on which one or more programs are stored,
in which the one or more programs, when executed by the one or more processors, enable the one or more processors to implement the training method of an object detection model according to the first aspect, or to implement the object detection method according to the second aspect.

In a sixth aspect, the present disclosure further provides a computer-readable storage medium on which a computer program is stored, and the computer program, when executed by a processor, implements the training method of an object detection model according to the first aspect, or implements the object detection method according to the second aspect.

### BRIEF DESCRIPTION OF DRAWINGS

FIG. 1 is a schematic diagram of training an object detector;

FIG. 2 is a schematic diagram of an exemplary application scenario provided by at least one embodiment of the present disclosure;

FIG. 3 is a flowchart of a training method of an object detection model provided by at least one embodiment of the present disclosure;

FIG. 4a is a schematic diagram of a multi-dataset object detection method provided by at least one embodiment of the present disclosure;

FIG. 4b is a schematic diagram of another multi-dataset object detection method provided by at least one embodiment of the present disclosure;

FIG. 4c is a schematic diagram of another multi-dataset object detection method provided by at least one embodiment of the present disclosure;

FIG. 4d is a schematic diagram of another multi-dataset object detection method provided by at least one embodiment of the present disclosure;

FIG. 5 is a schematic diagram of yet another multi-dataset object detection method provided by at least one embodiment of the present disclosure;

FIG. 6 is a flowchart of an object detection method provided by at least one embodiment of the present disclosure;

FIG. 7 is a schematic structural diagram of a training apparatus of an object detection model provided by at least one embodiment of the present disclosure;

FIG. 8 is a schematic structural diagram of an object detection apparatus provided by at least one embodiment of the present disclosure; and

FIG. 9 is a schematic diagram of a basic structure of an electronic device provided by at least one embodiment of the present disclosure.

### DETAILED DESCRIPTION

In order to make the above-mentioned objects, features and advantages of the present disclosure more obvious and easy to understand, the embodiments of the present disclosure will be further described in detail with the drawings and specific embodiments.

It may be understood that before using the technical solutions of various embodiments of the present disclosure, users will be informed of the types, application scope and usage scenarios of personal information involved in an appropriate way, and the authorization of users will be obtained.

For example, in response to receiving the user's active request, prompt information is sent to the user to clearly remind the user that the requested operation will require acquiring and using the user's personal information. Therefore, the user can independently choose whether to provide personal information to software or hardware such as electronic devices, application programs, servers or storage media that perform the operations of the technical solutions of the present disclosure according to the prompt information.

As an optional but non-limiting implementation, in response to receiving the user's active request, the way to send the prompt information to the user may be, for example, a pop-up window, in which the prompt information may be presented in text. In addition, the pop-up window may also carry a selection control for the user to choose “agree” or “disagree” to provide personal information to the electronic device.

It may be understood that the above-mentioned process of notifying and acquiring user authorization is only schematic and does not limit the implementations of the present disclosure, and other ways to meet relevant laws and regulations may also be applied to the implementations of the present disclosure.

Object detection is one of the important tasks in computer vision technology, and performing object detection on an image can identify the position and category of objects in the image. Multi-dataset object detection is to train one object detector on multiple datasets at the same time, and the label space of different datasets is different, so the object detector obtained by training can detect multiple types of objects in the image. For example, the objects are people, bicycles, hair dryers, snowboards, chairs, sandwiches, etc., and the categories of these objects are different.

Referring to FIG. 1, FIG. 1 is a schematic diagram of training an object detector. Next, the training process of the object detector is introduced with reference to FIG. 1. Among them, the acquisition process of labels for multi-datasets is introduced in detail.

Taking dataset A (Data A) and dataset B (Data B) as examples, both dataset A and dataset B are image datasets, and the data in the datasets are image data. For example, dataset A only has animal labels and dataset B only has vehicle labels, so the label spaces of the two datasets are different. The animal label is the real label of dataset A, that is, only the object category of animals in the images of dataset A is labeled; and the vehicle label is the real label of dataset B, that is, only the object category of vehicles in the images of dataset B is labeled.

First, two separate detectors are trained with dataset A and dataset B, for example, detector Det_{A} is trained with dataset A and label GA (i.e., animal label) of dataset A, and detector Det_{B} is trained with dataset B and label GB (i.e., vehicle label) of dataset B. Then, the detector Det_{A} trained by the dataset A is used to label the dataset B with a pseudo label PB (i.e., an animal pseudo label); and the detector Det_{B} trained by the dataset B is used to label the dataset A with a pseudo label PA (i.e., a vehicle pseudo label). It should be understood that pseudo labels are also regarded as labeling information. So far, the label spaces of the two datasets are consistent (that is, the two datasets are both labeled with animal labels and vehicle labels). Furthermore, an object detector Det is jointly trained based on the dataset A and the dataset B with the same label space, and the object detector obtained by training can detect multiple categories of objects at the same time, that is, can simultaneously detect two categories of objects in the image: animals and vehicles.

However, in the above-mentioned method, the process of labeling the pseudo label is only once, which makes the obtained pseudo label contain a lot of noise. Moreover, the domain differences between different datasets are not considered in the above-mentioned process of acquiring pseudo labels. This leads to poor quality of pseudo labels, and further makes the detection performance of the trained object detector poor. Therefore, it is necessary to improve the pseudo label manually, which leads to high labeling cost.

Based on this, the embodiments of the present disclosure provide a training method, apparatus and device of an object detection model. In the training process of the object detection model, an input image is first acquired, and the input image is labeled with a real label. A pseudo label of the input image is determined based on the object detection model. At the same time, a multi-object detection result of the input image is determined based on an auxiliary detection model. A first loss is calculated according to the multi-object detection result of the input image and the real label of the input image, and a second loss is calculated according to the multi-object detection result of the input image and the pseudo label of the input image. Further, the auxiliary detection model is updated based on the first loss and the second loss, and the object detection model is updated based on the auxiliary detection model. Further, the acquiring the input image, determining the object pseudo label of the input image based on the object detection model, and subsequent steps are continuously executed until a preset condition is reached. In this way, during the training process of the object detection model, the pseudo label of the input image is always automatically optimized and updated, so that the quality of the pseudo label is gradually improved. Moreover, the improvement of the quality of the pseudo label and the improvement of the training performance of the object detection model complement each other, which makes the detection performance of the final object detection model stronger.

It may be understood that the shortcomings of the above-mentioned solution are the results obtained by the applicant after practice and careful study. Therefore, the discovery process of the above-mentioned problems and the solutions proposed by the embodiments of the present disclosure below should be the applicant's contribution to the embodiments of the present disclosure.

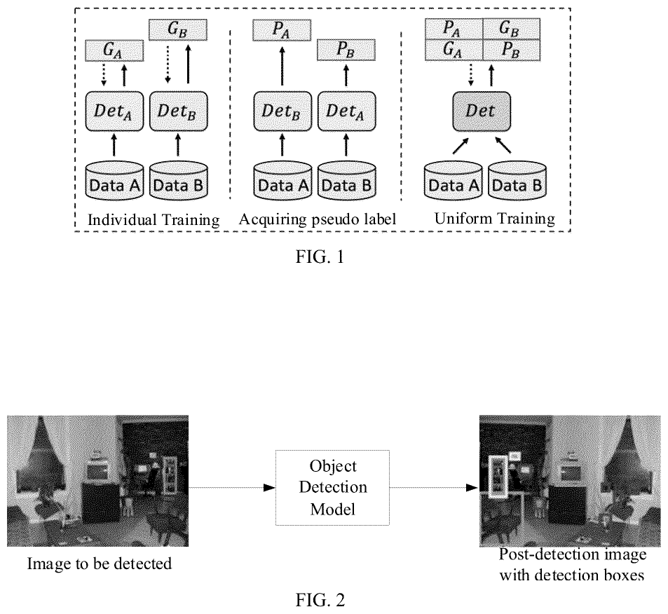

In order to facilitate the understanding of the object detection method provided by the embodiments of the present disclosure, the following description will be made in combination with a scenario example shown in FIG. 2. Referring to FIG. 2, which is a schematic diagram of an exemplary application scenario provided by at least one embodiment of the present disclosure, the method may be applied to a terminal device or a server, and is not limited here.

In practical application, after acquiring an image to be detected shown on the left in FIG. 1, the image to be detected is input into a trained object detection model to acquire a multi-object detection result of the image to be detected output by the object detection model. The multi-object detection result of the image to be detected includes the coordinate information of each detection box in the image to be detected and the object category of each detection box. The object category of the detection box is the category of the object in the detection box. For example, if the object in the detection box is a vehicle, the object category of the detection box is vehicle.

In order to realize the visualization of the object position in the image to be detected, as shown in the image on the right of FIG. 2, each detection box may also be labeled in the image to be detected based on the coordinate information of each detection box. In this way, the positions of different detection boxes in the image to be detected can be determined intuitively. The position of the detection box may also indicate the position of the object in the detection box. In addition, the category of the object in each detection box may be marked at an edge of the detection box to intuitively understand the category of the object in the detection box.

For example, the object detection model is obtained by pre-training, and the training process of the object detection model will be introduced in detail later.

It may be understood by those skilled in the art that the schematic diagram of the framework shown in FIG. 2 is only one example in which the embodiments of the present disclosure may be implemented. The scope of application of the embodiments of the present disclosure is not limited by any aspect of this framework.

In order to facilitate the understanding of the present disclosure, a training method of an object detection model provided by at least one embodiment of the present disclosure will be described below with reference to the drawings.

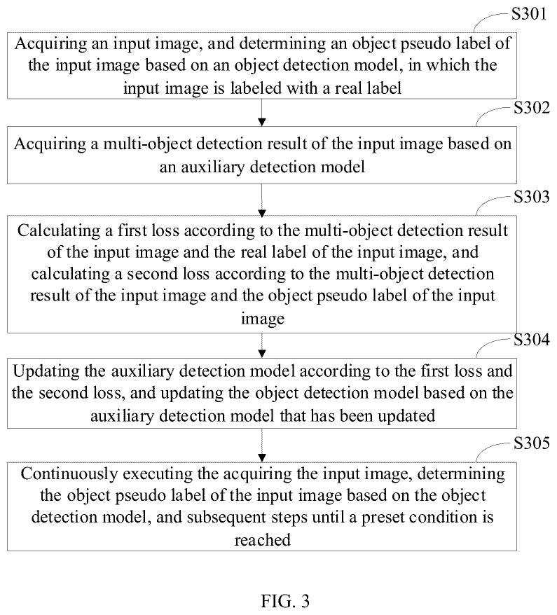

Referring to FIG. 3, which is a flowchart of a training method of an object detection model provided by at least one embodiment of the present disclosure, the method includes S301-S305.

S301: acquiring an input image, and determining an object pseudo label of the input image based on an object detection model, in which the input image is labeled with a real label.

In the embodiments of the present disclosure, the object detection model is trained based on multi-dataset, and the input image is any image in the multi-dataset. For example, the multi-dataset includes at least two datasets, and the datasets are specifically image datasets. Moreover, each dataset has its own label space, and the label space of each dataset is not uniform. That is, the foreground and background definitions of each dataset are different. In addition, the total number of object categories in the dataset used to train the object detection model is determined.

For example, the multi-dataset includes dataset A and dataset B, and the two datasets include 80 different object categories such as people, bicycles, hair dryers, . . . , snowboards, chairs and sandwiches. For the convenience of description, in the embodiments of the present disclosure, the object category may be simply referred to as category. The category of an object in any image of the multi-dataset is one of the 80 categories. 40 categories are labeled in dataset A, and another 40 categories are labeled in dataset B. Then in their respective dataset labels, 40 categories of objects will be labeled as foreground in dataset A, while the other 40 categories of objects will be ignored as background. In dataset B, the other 40 categories of objects will be labeled as foreground, while the 40 categories of objects labeled in dataset A will be ignored as background.

The real label labeled in the input image includes the coordinate information of a detection box and the real category of the object in the detection box. That is, if the input image is an image in the dataset A, and because the dataset A is labeled with 40 categories, the real category of any real label of the input image belongs to the 40 categories labeled in the dataset A. If the input image is an image in the dataset B, and because the dataset B is labeled with another 40 categories, the real category of the object in any real label of the input image belongs to the other 40 categories labeled in the dataset B. For visualization, the detection box may also be labeled in the input image based on the coordinate information of the detection box.

As an optional example, the real label of the input image may be manually labeled. Here, the acquisition method of the real label of the input image is not limited, and it may also be acquired according to other methods. It should be understood that the coordinate information of the detection box in the real label and the category of the object in the detection box are both real and have high accuracy.

After acquiring the input image and determining the real label of the input image, an object pseudo label of the input image is determined based on the object detection model. As an optional example, the input image is input into the object detection model, and the object detection model outputs the object pseudo label of the input image. In the embodiments of the present disclosure, the object detection model is the object detector, and the acquisition of the object detection model depends on the training of the auxiliary detection model.

As an optional example, the auxiliary detection model and the object detection model are both object detection networks with the same network structure. For example, the object detection network is a ResNet50 network. For example, the object detection model may be called teacher model, and the auxiliary detection model may be called student model. The object detection model is only responsible for acquiring the object pseudo label of the input image, and does not participate in the iterative training of the model. The auxiliary detection model participates in the iterative training of the model.

In order to facilitate understanding, the following will introduce the process of acquiring the object pseudo label of the input image after the input image is input into the object detection model.

In concrete implementation, after the input image is input into the object detection model, the coordinate information of each detection box in the input image and the classification result of the object in each detection box are output. The coordinate information of the detection box and the classification result of the object in the detection box constitute the information of the detection box.

The classification result of the object in the detection box may be expressed by category probability, which is used to indicate the probability that the object in the detection box is a certain category, and the category probability is a value in the interval [0,1]. For example, when the total number of categories of objects in the multi-dataset is 80, the classification result of the object in the detection box may specifically include 80 category probabilities, and each category probability corresponds to one category. For example, the first category probability among the 80 category probabilities is used to indicate the probability that the object in the detection box is a “person”.

The pseudo category of the object in the detection box may be determined based on the classification result of the object in the detection box. The coordinate information of the detection box and the pseudo category of the object in the detection box constitute the object pseudo label of the input image.

For example, in response to the first category probability being greater than a corresponding category probability threshold, it is determined that the object in the detection box is the category of “people” (which may be called a pseudo category and corresponds to the real category). The category probability threshold is not limited, and may be limited according to the actual situation. The remaining category probabilities are similar to this and will not be described again here.

It should be understood that the categories of objects in some detection boxes are one or more of the real categories in the real labels (that is, the 40 labeled object categories). For example, “person” is the real category in the real label, and these categories need not be considered when determining the object pseudo label. Therefore, the information of these detection boxes cannot be used as an object pseudo label. Based on this, these detection boxes may be filtered out, and the information of the remaining detection boxes may be used as object pseudo labels. It should be understood that the above examples are only for illustration and not for limitation.

The above describes the process of acquiring the object pseudo label of the input image. The object pseudo label of the input image also includes the coordinate information of the detection box and the pseudo category of the object in the detection box. For the convenience of understanding and distinguishing, the detection box in the object pseudo label of the input image may also be called a pseudo box. It may be understood that the pseudo categories of objects in respective detection boxes in the object pseudo label are the other 40 object categories that are not labeled. That is, the object pseudo label of the input image is used as the labeling information of the other 40 object categories that are not initially labeled in the input image. In the embodiments of the present disclosure, with the training and updating of the auxiliary detection model, the object pseudo label of the input image is also iteratively updated, to acquire the object pseudo label with higher quality, and then the auxiliary detection model with better performance may be obtained by subsequent training based on the object pseudo label with higher quality, so that the detection performance of the object detection model is higher.

For visual viewing, after acquiring the object pseudo label of the input image, both the detection box in the real label and the detection box in the object pseudo label may be labeled in the input image. In practical application, in order to distinguish, detection boxes with different colors may be used to represent the detection boxes in the real label and the detection boxes in the object pseudo label.

In one possible implementation, the embodiments of the present disclosure provide a specific implementation of determining the object pseudo label of the input image based on the object detection model. See A1-A3 below for details.

S302: acquiring a multi-object detection result of the input image based on an auxiliary detection model.

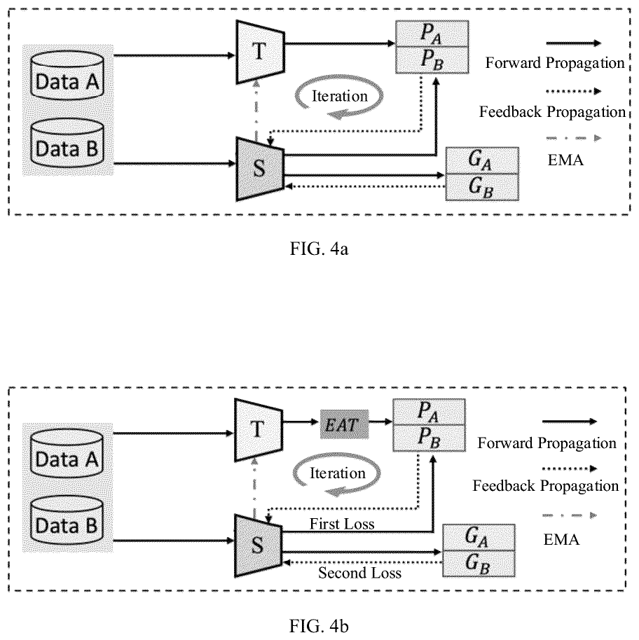

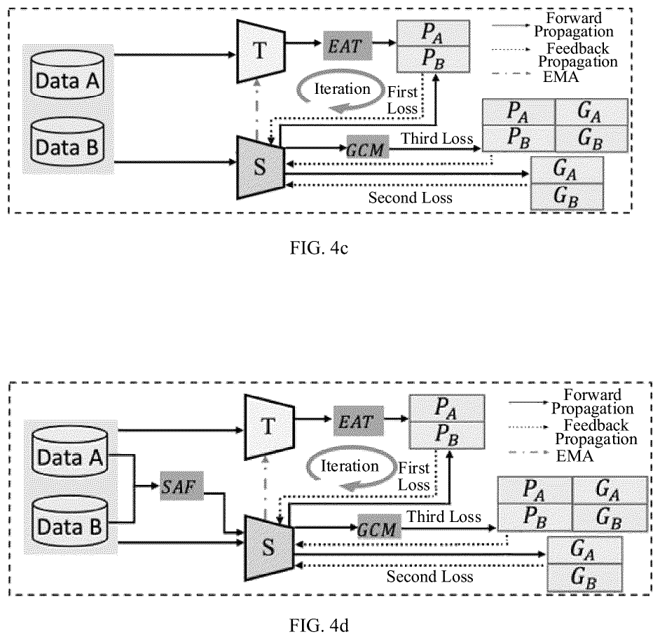

Referring to FIG. 4a, FIG. 4a is a schematic diagram of a multi-dataset object detection method provided by at least one embodiment of the present disclosure. In FIG. 4, “T” represents a teacher model, that is, the object detection model, and “S” represents a student model, that is, the auxiliary detection model. As an optional example, any input image in dataset A and dataset B may be simultaneously input into the object detection model and the auxiliary detection model. It may be understood that the order in which the input image is input into the object detection model and the auxiliary detection model is not limited, and the auxiliary detection model may be input first, and then the object detection model is input.

As an optional example, the input image is input into the auxiliary detection model to acquire the multi-object detection result of the input image. The multi-object detection result includes prediction coordinate information of each prediction detection box in the input image and a prediction classification result of the object in each detection box. Understandably, the multi-object detection result is a predicted value.

In one possible implementation, the embodiments of the present disclosure provide a specific implementation of acquiring the multi-object detection result of the input image based on the auxiliary detection model in S302, see C1-C5 below for details.

S303: calculating a first loss according to the multi-object detection result of the input image and the real label of the input image, and calculating a second loss according to the multi-object detection result of the input image and the object pseudo label of the input image.

As shown in FIG. 4a, the real label of the input image may be represented by GA and GB, and the object pseudo label of the input image may be represented by PA and PB. The subscript A indicates that the input image is from dataset A, and the subscript B indicates that the input image is from dataset B. Understandably, the real label and the object pseudo label of the input image are both label information of the input image, which are regarded as real values to be used for the supervision of the auxiliary detection model.

The first loss is calculated according to the multi-object detection result (which may be regarded as a predicted value) of the input image and the real label (which may be regarded as a real value) of the input image, and the second loss is calculated according to the multi-object detection result of the input image and the object pseudo label (which may be regarded as a real value) of the input image.

As an optional example, the categories (real category and pseudo category) of the object in the detection box in the label (including the real label and the pseudo label) may be represented by “1” and “0”. Where “1” means that the category appears, and “0” means that the category does not appear.

In order to calculate the first loss and the second loss, the vector representation of the real label and the object pseudo label and the element content in the vector are introduced first.

For example, there are 40 real categories of the object in the detection box labeled in the real label, and another 40 pseudo categories of the object in the detection box labeled in the object pseudo label. It may be seen that both the real label and the object pseudo label are partial labels of the input image. However, the prediction classification result of the object in the prediction detection box in the multi-object detection result is composed of prediction category probabilities of 80 categories. For example, the category of the object in the detection box in each label may be represented by a vector of 80*1 dimension, representing the 0th category-the 79th category. The element in the vector is “1” or “0”. If the first element is “0” and the first element corresponds to the 0th category (such as “people”), it means that there is no object of this category in the detection box, and so on. Based on this, if the real label is labeled with the 0th category-the 39th category (that is, the real category), and the object pseudo label is labeled with the 40th category-the 79th category (that is, the pseudo category), then only the first 40 elements in the 80*1-dimensional vector used to represent the real label category are label values (such as “0” or “1” to represent the labeled real category), and the values of the last 40 elements are empty. The category of the detection box in the object pseudo label is also represented by an 80*1-dimensional vector, then the first 40 elements in the vector are empty, and the values of the last 40 elements are the label values (such as “0” or “1” to represent the labeled pseudo category). In the multi-object detection result, the prediction classification result of the object in the prediction detection box is also represented by an 80*1-dimensional vector, and each element in this vector is represented as a prediction category probability, and each element is not empty.

It may also be understood that the above only describes the category of the object in the detection box in the label (including the real category of the object in the detection box in the real label and the pseudo category of the object in the detection box in the object pseudo label) and the prediction classification result of the object in the prediction detection box, and the coordinate information of the detection box and the prediction coordinate information of the prediction detection box are similar to this, which will not be described here. That is, the category of the object in the detection box, the prediction classification result of the object in the prediction detection box, the coordinate information of the detection box and the prediction coordinate information of the prediction detection box are all used to calculate the first loss and the second loss.

Combined with the understanding of the above introduction, for example, the first loss in this step is set as the loss of the label value and the predicted value only for the 0th-39th category, that is, the loss of the corresponding predicted value only for the real category of the object in the detection box in the real label and the prediction classification result of the object in the prediction detection box. The second loss is set as the loss of the label value and the predicted value only for the 40th-79th category, that is, the loss of the corresponding predicted value only for the pseudo category of the object in the detection box in the object pseudo label and the prediction classification result of the object in the prediction detection box. It should be understood that this example is only for illustration and does not constitute a limitation.

In practice, a first preprocessing loss value is calculated according to the multi-object detection result of the input image and the real label of the input image. Continuing to explain based on the above example, the first preprocessing loss value also includes the loss of the label value and the predicted value of the 40th-79th category, that is, the loss corresponding to the category not labeled in the real label. On this basis, this part of the loss in the first preprocessing loss value (that is, the loss corresponding to the category not labeled in the real label) is shielded to avoid the feedback propagation of this part of the loss, thus obtaining the first loss. In addition, a second preprocessing loss value is calculated according to the multi-object detection result of the input image and the object pseudo label of the input image. The second preprocessing loss value also includes the loss of the label value and the predicted value of the 0th-39th category, that is, the loss corresponding to the category not labeled in the object pseudo label. On this basis, this part of the loss in the second preprocessing loss value (that is, the loss corresponding to the category not labeled in the object pseudo label) is shielded to avoid the feedback propagation of this part of the loss, thus obtaining the second loss.

It may be understood that the first loss is the loss of the category labeled in the real label and its corresponding predicted value, and the second loss is the loss of the category labeled in the object pseudo label and its corresponding predicted value. That is, both the first loss and the second loss are partial losses.

In practical application, loss functions may be designed to calculate the first loss and the second loss respectively, and the designed loss functions are not limited here.

S304: updating the auxiliary detection model according to the first loss and the second loss, and updating the object detection model based on the auxiliary detection model that has been updated.

The first loss is the loss corresponding to the real label, and the second loss is the loss corresponding to the object pseudo label. As shown in FIG. 4a, the auxiliary detection model is updated by using the first loss and the second loss of feedback propagation, specifically, the parameters of the auxiliary detection model are adjusted by using the first loss and the second loss, and the adjusted parameters of the auxiliary detection model are acquired.

As an optional example, after acquiring the first loss and the second loss, the first loss and the second loss may be weighted and summed, and then the auxiliary detection model may be trained by using the loss obtained by the weighted summation. For example, a first product of the first loss and a weight corresponding to the first loss is calculated, and a second product of the second loss and a weight corresponding to the second loss is calculated. The first product can represent the weighted first loss, and the second product can represent the weighted second product. The sum of the first product and the second product is the result of the weighted summation.

Optionally, the first product and the second product may be kept within the same order of magnitude by setting the weight corresponding to the first loss and the weight corresponding to the second loss, that is, making the weighted losses more balanced.

Optionally, during the initial stage of training the auxiliary detection model, the weight corresponding to the first loss may be set higher and the weight corresponding to the second loss may be set lower; and during the middle and late stage of training the auxiliary detection model, the weight corresponding to the first loss and the weight corresponding to the second loss are adjusted to make the weighted losses more balanced.

The embodiments of the present disclosure provide a specific embodiment of updating the auxiliary detection model according to the first loss and the second loss in S304. See below for details.

As an optional example, after each update of the parameters of the auxiliary detection model, the parameters of the auxiliary detection model may be directly assigned to the object detection model, so that the parameters of the object detection model and the auxiliary detection model are the same. In this way, the updated auxiliary detection model is used to update the object detection model.

As an optional example, the parameters of the auxiliary detection model may also be updated to the object detection model by Exponential Moving Average (EMA). It may be understood that the embodiments of the present disclosure do not limit the migration mode of parameters.

S305: continuously executing the acquiring the input image, determining the object pseudo label of the input image based on the object detection model, and subsequent steps until a preset condition is reached.

Continuously executing the acquiring the input image, and determining the object pseudo label of the input image based on the object detection model in S301, and the subsequent steps until the preset condition is reached, the training of the auxiliary detection model is finished. The preset condition may be that the training times of the model reach a preset number of times, or the first loss and the second loss reach their respective preset loss ranges. The embodiments of the present disclosure do not limit the preset number of times and the preset loss ranges, and may be set according to the actual situation.

It may be understood that in the process of updating the object detection model and continuously executing S301-S305, the object pseudo label of the input image is re-acquired. Because the object detection model is the updated model, the quality of the object pseudo label re-acquired based on the updated object detection model is higher than the quality of the last object pseudo label. Therefore, the training effect of the auxiliary detection model in the new round may be further improved, and the quality of the object pseudo label of the input image may be continuously improved when S301-S305 are executed continuously. Therefore, in the training process of the auxiliary detection model, the quality of the object pseudo label is continuously optimized to make it more and more refined, and at the same time, the training effect of the auxiliary detection model is continuously improved, so that the detection performance of the trained object detection model is higher.

It can be seen that the trained object detection model is a universal and extensive model, which can realize the simultaneous detection of multiple object categories in the image to be detected.

Based on the related contents of S301-S305, the embodiments of the present disclosure provide a training method of an object detection model. In the training process of the object detection model, an input image is acquired, and the input image is labeled with a real label. An object pseudo label of the input image is determined based on the object detection model. At the same time, a multi-object detection result of the input image is determined based on an auxiliary detection model. A first loss is calculated according to the multi-object detection result of the input image and the real label of the input image, and a second loss is calculated according to the multi-object detection result of the input image and the object pseudo label of the input image. Further, the auxiliary detection model is updated based on the first loss and the second loss, and the object detection model is updated based on the auxiliary detection model. Further, the acquiring the input image, determining the object pseudo label of the input image based on the object detection model, and subsequent steps are continuously executed until a preset condition is reached. In this way, during the training process of the object detection model, the pseudo label of the input image is always automatically optimized and updated, so that the quality of the object pseudo label is gradually improved. Moreover, the improvement of the quality of the object pseudo label and the improvement of the training performance of the object detection model complement each other, which makes the detection performance of the final object detection model stronger.

Generally, the object detector will get a series of detection boxes with coordinates and confidence in the process of labeling pseudo labels on an image. The confidence is a value between the interval [0, 1], which is used to judge whether the object in the detection box is a positive sample or a negative sample. Generally, in response to the confidence being greater than the confidence threshold, the object in the detection box is determined to be a positive sample, that is, the object; and in response to the confidence being less than or equal to the confidence threshold, the object in the detection box is determined to be a negative sample, that is, the background. Understandably, when it is determined that there is an object in the detection box, the classification result of the object in the detection box is acquired. In this way, based on the confidence threshold, the obtained detection boxes may be filtered first to filter out the background boxes in the detection boxes. However, the constant confidence threshold is relatively rough. For example, when the constant threshold is low, the obtained detection box will contain many background boxes, which makes the quality of the pseudo label poor. When the constant threshold is high, although the quality of obtained positive samples is good, the number of positive samples is small, which will aggravate the imbalance between positive and negative samples.

In order to cope with this situation, the embodiments of the present disclosure introduce an entropy-guided adaptive threshold (EAT) module. Referring to FIG. 4b, FIG. 4b is a schematic diagram of another multi-dataset object detection method provided by at least one embodiment of the present disclosure. Compared with FIG. 4a, the EAT module is added in FIG. 4b. The EAT module and its function are described in detail below.

In one possible implementation, the embodiments of the present disclosure provide a specific implementation of determining the object pseudo label of the input image based on the object detection model, including:

A1: determining a preselected pseudo label of the input image based on the object detection model, in which the preselected pseudo label corresponds to a detection box confidence.

In concrete implementation, the input image is input into the object detection model, and a preselected pseudo label of the input image is output. The preselected pseudo label of the input image is also composed of the coordinate information of the detection box and the pseudo category of the object in the detection box, and the pseudo category of the object in the detection box is still determined based on the classification result of the object in the detection box. After filtering the preselected pseudo label, the final pseudo label of the input image is obtained. In this example, the preselected pseudo labels are filtered based on EAT.

It may be understood that the detection box in the preselected pseudo label may be called a preselected pseudo box, and the final pseudo box needs to be filtered from the preselected pseudo boxes, that is, the final pseudo label is obtained by filtering from the preselected pseudo labels.

A2: determining a first confidence threshold corresponding to each object category in the input image.

The first confidence threshold (which may be called t_h) is a filtering threshold, which is used to distinguish positive samples from other samples. That is, in response to the detection box confidence being greater than the first confidence threshold, the object in the detection box is regarded as a positive sample; and in response to the detection box confidence being less than or equal to the first confidence threshold, the object in the detection box is regarded as another sample.

In practical application, the dataset applied for training model is generally a long-tail distribution, and the long-tail distribution is a skewed distribution, which means that some categories (which may be called head categories) contain a lot of data, while most categories (which may be called tail categories) only have a very small amount of data. As a result, the data of head categories appears more times, and the data of tail categories appears less times. In order to improve the balance of positive samples obtained by filtering different object categories, the same first confidence threshold cannot be simply set for each object category in the input image. Instead, this step sets a corresponding first confidence threshold for each object category in the input image. It may be understood that each object category is specifically all object categories in the multi-dataset required for training the model, for example, 80 object categories.

The following will introduce the specific implementation of acquiring the first confidence threshold corresponding to each object category, as follows:

In one possible implementation, the preselected pseudo label may include a first preselected pseudo label and a second preselected pseudo label. The object category corresponding to the first preselected pseudo label belongs to a first category, and the object category corresponding to the second preselected pseudo label belongs to a second category. For example, the object category corresponding to the first preselected pseudo label is “person”, and “person” belongs to the first category. The object category corresponding to the second preselected pseudo label is “chair”, and “chair” belongs to the second category. Among them, the sample proportion of the first category is greater than the sample proportion of the second category, so the first category may be considered as the above-mentioned head category and the second category may be considered as the above-mentioned tail category.

As an optional example, the first confidence threshold of the object category corresponding to the first preselected pseudo label is greater than the first confidence threshold of the object category corresponding to the second preselected pseudo label.

Then based on this relationship, the first confidence threshold may be set for each object category in the input image.

Understandably, when the first category is represented by the head category and the second category is represented by the tail category, if an object category belongs to the head category (that is, the data of the object category belongs to the head data), the entropy of the detection box of the object category will be lower, the object detection model will be more convinced of this classification, and the entropy representing uncertainty will be lower (in information theory, lower entropy means lower uncertainty, and vice versa). Based on this, it is necessary to set a higher threshold for these object categories to improve the quality of object pseudo labels. If an object category belongs to the tail category (that is, the data of the object category belongs to the tail data), the entropy of the detection box of the object category will be higher, and it is necessary to set a relatively tolerant and low threshold for these object categories to increase the number of object pseudo labels.

For example, it can be determined whether an object category belongs to the head category or the tail category by calculating the proportion of the detection boxes of the object category in the real labels of the input image, in the detection boxes of all the real labels in the dataset to which the input image belongs. For example, the input image is from dataset A, and the object category of the detection box of one real label of the input image is “person”, then the proportion of the detection box with the object category of “person” in dataset A, in the detection boxes of all real labels in dataset A is counted. For example, the total number of detection boxes with the object category of “person” in dataset A is 500, and the total number of detection boxes of all real labels in dataset A is 10,000, so the proportion is 0.05. When the proportion exceeds the proportion threshold, the object category of “people” may be determined as the head category, otherwise it is the tail category. It may be understood that the embodiments of the present disclosure are not limited to specific proportional thresholds.

Based on the above, in another possible implementation, the embodiments of the present disclosure provide a specific implementation of determining the first confidence threshold corresponding to each object category in the input image, including: A21: calculating an entropy of the preselected pseudo label of the input image.

As an optional example, the formula for calculating the entropy H_{x,y} of the preselected pseudo label of the input image is as follows:

$${H}_{x , y} = - {{\sum }^{\vert {C}_{⋃} \vert}}_{i = 1} {p}_{x , y}^{i} log ( {p}_{x , y}^{i} ) ,$$

where (x, y) is the central coordinate of the preselected pseudo label, x is the abscissa in the central coordinate, and y is the ordinate in the central coordinate. It may be understood that when there are 80 object categories, the classification result of the object in the detection box in the preselected pseudo label may be expressed as an 80*1-dimensional vector, and each element in the vector represents a classification result, and the classification result is obtained by category probability. p_{x,y}ⁱ is the category probability corresponding to the i-th object category in the preselected pseudo label, and C represents all object categories.

A22: calculating an average entropy of each object category in the input image according to the entropy of the preselected pseudo label.

As an optional example, the formula for calculating the average entropy He of each object category in the input image is as follows:

$${H}^{c} = \frac{1}{{N}^{c}} {\sum }_{( x , y )} 1 ( {c}_{x , y} == c ) {H}_{x , y} ,$$

where c_{x,y} represents the object category predicted at (x, y), Cis one of the object categories, c_{x,y}==C represents the object category predicted at (x, y) is the object category C, and the confidence of the object category C is the highest among all the object categories. For example, when there are 80 object categories, recorded as the 0th object category to the 79th object category, then C=0 may be represented as the 0th object category among the 80 object categories. Accordingly, H^{o} represents the average entropy of the 0th object category. 1(c_{x,y}==C) is a conditional function, which means that the average entropy will be calculated only when (x, y) the object category predicted at (x, y) is the object category C. N^{c} represents the total number of predicted detection boxes in the object category C (detection boxes are detection boxes in the preselected pseudo label).

A23: calculating the first confidence threshold corresponding to each object category in the input image according to the average entropy of each object category in the input image.

As an optional example, the formula for calculating the first confidence threshold corresponding to each object category in the input image is as follows:

$${τ}_{h}^{c} = max ( {τ}_{min} , {( 1 - \frac{{H}^{c}}{{\sum }_{i = 1}^{\vert {C}_{⋃} \vert} {H}^{i}} )}^{γ} {τ}_{b a s e} ) ,$$

where τₕ^{c} represents the first confidence threshold of the object category C, and h represents the first confidence threshold. Hⁱ is the average entropy of the i-th object category, Σᵢ₌₁^{|c}^{_{∪}}^{|}Hⁱ represents the sum of the average entropy of all object categories, and the ranges of

$$\frac{{H}^{c}}{{\sum }_{i = 1}^{\vert {C}_{⋃} \vert} {H}^{i}}$$

and

$$1 - \frac{{H}^{c}}{{\sum }_{i = 1}^{\vert {C}_{⋃} \vert} {H}^{i}}$$

are both [0,1]. In order to prevent the first confidence threshold from being too small, it is set τₘᵢₙ as the minimum value of the first confidence threshold, for example, 0.25. τ_{base} is a basic threshold used to set the obtained first confidence threshold within an appropriate range, and τ_{base} may be determined based on the confidence range of the detection box and is not limited here, for example, τ_{base} is 0.35. γ is a fixed parameter value, which is used to balance the difficulty of classification.

By performing A21-A23, the corresponding first confidence threshold is set adaptively according to the entropy of each object category. It may be understood that the first confidence threshold of each object category may be updated according to A21-A23 in each training process of the auxiliary detection model and the object detection model. Alternatively, after training the auxiliary detection model and the object detection model for a preset number of times, the first confidence threshold of each object category is updated once based on A21-A23. The preset number of times is not limited, and may be set according to the actual situation.

A3: in response to the detection box confidence corresponding to the preselected pseudo label being greater than a first confidence threshold of a corresponding object category, retaining the preselected pseudo label, and determining the object pseudo label of the input image.

That is, the final pseudo label (which may be called object pseudo label) is determined from the preselected pseudo labels based on the first confidence threshold of each object category, which improves the quantity and quality of the object pseudo label of the input image.

It may be understood that the first confidence threshold obtained through A1-A2 may be adapted to the proportional relationship of “the first confidence threshold of the object category corresponding to the first preselected pseudo label being higher than the first confidence threshold of the object category corresponding to the second preselected pseudo label”.

Based on the above, in addition to setting the first confidence threshold, a second confidence threshold may also be set. As follows:

A4: determining a second confidence threshold corresponding to each object category in the input image, in which the second confidence threshold is less than the first confidence threshold of the same object category.

The second confidence threshold (which may be called t_1) is another filtering threshold, which is used to divide negative samples and uncertain samples among other samples. The second confidence threshold is less than the first confidence threshold of the same object category. That is, the embodiments of the present disclosure set the first confidence threshold and the second confidence threshold for the same object category.

As an optional example, the second confidence thresholds corresponding to different object categories may be the same empirical threshold, for example, 0.1. It may be understood that different second confidence thresholds may also be set for different object categories, which is not limited here.

A5: in response to the detection box confidence corresponding to the preselected pseudo label being greater than or equal to a second confidence threshold of a corresponding object category and less than or equal to the first confidence threshold of the same object category, taking the preselected pseudo label as an uncertain pseudo label.

In response to the detection box confidence corresponding to the preselected pseudo label being greater than or equal to the second confidence threshold of the corresponding object category and less than or equal to the first confidence threshold of the same object category, the object in the detection box is taken as an uncertain sample, which indicates that the detection accuracy of the object detection model for this category is low. The preselected pseudo label is taken as an uncertain pseudo label, and the uncertain pseudo label does not produce losses in the process of model training. It may be seen that in the embodiments of the present disclosure, the uncertain samples are not simply divided into positive samples or negative samples, but a more accurate sample division is given. In this way, the quality of the object pseudo label may be improved.

It may be understood that based on the above, the first confidence threshold is actually used to divide uncertain samples and positive samples.

A6: in response to the detection box confidence corresponding to the preselected pseudo label being less than the second confidence threshold corresponding to each object category, taking the preselected pseudo label as a background pseudo label.

In response to the detection box confidence corresponding to the preselected pseudo label being less than the second confidence threshold corresponding to each object category, the object in the detection box is taken as a negative sample (i.e., background), and the preselected pseudo label is taken as a background pseudo label. When visualizing labels, real labels, object pseudo labels and uncertain pseudo labels can be visualized.

Based on the contents of A1-A6, the embodiments of the present disclosure provide an adaptive threshold strategy based on EAT, and set a corresponding first confidence threshold for extracting the object pseudo label for each object category in the dataset, to optimize the quality of the object pseudo label, thereby improving the detection performance of the object detection model obtained finally.

The object detection model generally includes a feature extraction network and a detection head, and the detection head is used to output the coordinate information of the detection box and the classification result of the object in the detection box. It should be understood that the classification and regression operations of the object in the detection box are generally carried out in the local area near the detection box, that is, the detection head does the classification task based on the local information of the input image, and it cannot acquire the global information of the object in the detection box in the input image. Therefore, there may be some errors in the classification result of the object in the detection box.

For example, the object in the detection box is an elephant ornament on the table, and the local area near the detection box only includes some local information. If the detection head determines whether the object is an elephant only based on the local information, it is easy to determine the object as an elephant. But judging from the global information of the input image, there should be no elephants on the table. Based on this, in order to guide the detection head to make correct classification, the embodiments of the present disclosure provide a Global Classification Module (GCM) to provide global features, see below for details.

As an alternative example, the auxiliary detection model includes a feature extraction network. Referring to FIG. 4c, FIG. 4c is a schematic diagram of another multi-dataset object detection method provided by at least one embodiment of the present disclosure. With reference to FIG. 4c, the method provided by the embodiments of the present disclosure further includes the following steps:

B1: acquiring a feature map of the input image extracted by the feature extraction network.

The feature map of the input image extracted by the feature extraction network is specifically the last layer of the feature map of the auxiliary detection model. For example, when the auxiliary detection model is ResNet50, four layers of feature maps will be acquired, and the feature map of the input image extracted by the feature extraction network is a feature map output by the fourth layer.

It may be understood that the last layer of feature map may not only represent the global features of the input image, but also the semantic information of the last layer of feature map is relatively complete, which can represent the complete global information of the input image, which is helpful for the subsequent detection box classification task.

B2: inputting the feature map into a global classification module to acquire a global classification result of the input image.

The global classification result is the result obtained by considering the global information of the input image, and the global classification result indicates the possibility of various categories in the input image, which may be expressed by the probability of various categories. For example, the probability of each category in the global classification result corresponds to a category in the multi-dataset.

For example, when the multi-dataset includes 80 different categories (represented as the 0th-79th category), the global classification result may be specifically composed of 80 category probabilities, which may be represented by an 80*1-dimensional vector. Each element in the 80*1-dimensional vector represents the category probability that the corresponding object category exists in the input image. For example, the first element in the vector corresponds to the 0th category, indicating the category probability that the 0th category exists in the input image. Then when the 0th category is “people”, the first element of the vector represents the probability that a “person” exists in the input image. It should be understood that the example in this step is for illustration and not for limitation.

B3: acquiring a third loss according to the global classification result and a global classification label.

As an optional example, the global classification label of the input image is composed of the real label of the input image and the object pseudo label of the input image. As another optional example, the global classification label of the input image may also be composed of all the real labels labeled by the input image, that is, all the categories in the multi-dataset are labeled. It may be understood that the embodiments of the present disclosure do not limit the acquisition method of the global classification label, and the above description is only taken as an example, which may be determined according to the actual situation.

It may be understood that both the real label of the input image and the object pseudo label of the input image are partial labels. The global classification label of the input image is composed of a real label and an object pseudo label, so the global classification label can represent the complete labeling information of the input image.

It may also be understood that when the global classification label includes a real label and an object pseudo label, the label includes not only the category of the object in the detection box, but also the coordinate information of the detection box. For example, when the label is a real label, the category of the object in the detection box is specifically the real category of the object in the detection box; and when the label is an object pseudo label, the category of the object in the detection box is specifically the pseudo category of the object in the detection box.

Because the global classification result only indicates the possibility of various categories in the input image, in the process of calculating the third loss, when using the global classification label, only the category of the object in the detection box is used, and the coordinate information of the detection box is not used.

The third loss represents the difference between the global classification result and the category of the object in the detection box in the global classification label, and the third loss may be considered as a global classification loss. Taking the 0th category as an example, if the category probability that the 0th category in the global classification result exists in the input image is 0.7 (indicating that there is a high probability that the 0th category exists in the input image), and the probability that the object in the detection box in the global classification label is the 0th category is 0 (that is, indicating that the object in the detection box is not the 0th category), the third loss includes the loss caused by the difference between 0.7 and 0. Understandably, the global classification result represents the global information of the input image, and the third loss is constructed through the global classification result, so that the supervision of the global information is added in the process of training the auxiliary detection model, so that the auxiliary detection model may further learn the global features and improve the accuracy of the object detection.

Based on this, as shown in FIG. 4c, the embodiments of the present disclosure provide a specific implementation of updating the auxiliary detection model according to the first loss and the second loss in S304, including:

Updating the auxiliary detection model according to the first loss, the second loss and the third loss.

It may be seen that the addition of the third loss means that the supervision of the global information of the input image is added. As an optional example, the first loss, the second loss and the third loss may be weighted and summed, and the auxiliary detection model may be trained according to the loss obtained by the weighted summation.

Specifically, a first product of the first loss and the weight corresponding to the first loss is calculated, a second product of the second loss and the weight corresponding to the second loss is calculated, and a third product of the third loss and the weight corresponding to the third loss is calculated. The first product represents the weighted first loss, the second product represents the weighted second product, and the third product represents the weighted third product. The sum of the first product, the second product and the third product is the result of weighted summation.

Optionally, the first product, the second product and the third product may be kept within the same order of magnitude by setting the weight corresponding to the first loss, the weight corresponding to the second loss, and the weight corresponding to the third loss, that is, making the weighted losses more balanced.

Optionally, during the initial stage of training the auxiliary detection model, the weight corresponding to the first loss may be set higher, and the weight corresponding to the second loss and the weight corresponding to the third loss may be set lower; and during the middle and late stage of training the auxiliary detection model, the weight corresponding to the first loss, the weight corresponding to the second loss, and the weight corresponding to the third loss are adjusted to make the weighted losses more balanced.

Understandably, taking the elephant in the above example as an example, after the GCM module is added, the probability that there is an elephant in the input image in the obtained global classification result should be very low, thus realizing the supervision of global information.

As an optional example, the global classification module includes a global feature extraction module.

Based on this, the embodiments of the present disclosure provide a specific implementation of inputting a feature map into a global classification module to acquire a global classification result of the input image in B2, including:

B21: inputting the feature map into the global feature extraction module to acquire an output feature map, in which the output feature map is used to represent global information of the input image.

The global feature extraction module is used to acquire the global information of the feature map. The global information of the feature map can represent the global information of the input image.

As an optional example, the global feature extraction module is SE Attention Block, which is used to enhance the features of the feature map.

B22: acquiring the global classification result of the input image based on the output feature map.

After acquiring the output feature map, the global classification result of the input image may be acquired based on the output feature map. For example, the image classification operation is performed based on the output feature map to acquire the global classification result of the input image.

It may be understood that the global information in the output feature map is more accurate, which makes the obtained global classification result of the input image to be processed more accurately.

As an optional example, the global classification module further includes a Global Average Pooling (GAP) module and a Multilayer Perceptron (MLP) module. The MLP module consists of at least two fully connected layers. Based on this, the embodiments of the present disclosure provide a specific implementation of acquiring the global classification result of the input image based on the output feature map in B22, including:

B221: inputting the output feature map into the global average pooling module, and inputting the output of the global average pooling module into the MLP module to acquire the global classification result of the input image to be processed.

The global average pooling module is used to reduce the dimension of the output feature map to map the dimension to the label space. The MLP module is used to realize classification and acquire the global classification results of the input image to be processed.

B222: inputting the classification result to be processed into a normalization module to acquire the global classification result of the input image.

The normalization module includes a Sigmoid function σ, which is used to process the global classification result to be processed into a probability within the range of (0,1), to acquire the category probability of each object category in the global classification result.

In addition, it is known that the global classification result indicates the probability of various categories in the input image, and the object pseudo label may be modified based on the global classification result when labeling the object pseudo label on the input image.

Specifically, after determining the preselected pseudo label of the input image and before determining the first confidence threshold corresponding to each object category in the input image, the method provided by the embodiments of the present disclosure further includes the following step:

Adjusting the preselected pseudo label of the input image based on the global classification result.

It may be understood that, as described in S301, the object pseudo label of the input image is composed of the coordinate information of the detection box and the pseudo category of the object in the detection box, and the pseudo category of the object in the detection box is determined based on the classification result of the object in the detection box. The preselected pseudo label may be understood as an initial pseudo label of the input image, and the final pseudo label (as described in A1) of the input image may be obtained after filtering the initial pseudo label.

Therefore, the preselected pseudo label of the input image is also composed of the coordinate information of the detection box and the pseudo category of the object in the detection box, and the pseudo category of the object in the detection box is also determined based on the classification result of the object in the detection box. Then “adjusting the preselected pseudo label of the input image based on the global classification result” specifically means adjusting the classification result of the object in the detection box in the preselected pseudo label based on the global classification result. When the classification result of the object is expressed by category probability, it is actually the category probability that is adjusted. It may be understood that adjusting the classification result of the object in the detection box actually realizes the adjustment of the preselected pseudo label of the input image. In this way, supervising the preselected pseudo label of the input image based on the global classification result can improve the quality of the preselected pseudo label, which is helpful to improve the quality of the final pseudo label.

As an optional example, when both the global classification result and the classification result of the object in the detection box are expressed by category probability, the product of the global classification result and the classification result of the object in the detection box in the preselected pseudo label is calculated, and the product is taken as the classification result of the object in the detection box in the preselected pseudo label again. Finally, the product and the coordinate information of the detection box are re-formed into the preselected pseudo label of the input image.

As another optional example, when the global classification result and the classification result of the object in the detection box are both expressed by category probability, a preset threshold is set, and the global classification result is binarized by the preset threshold to acquire the processed global classification result. Furthermore, the product of the processed global classification result and the classification result of the object in the detection box in the preselected pseudo label is calculated, and the product is taken as the classification result of the object in the detection box in the preselected pseudo label again. Finally, the product and the coordinate information of the detection box are re-formed into the preselected pseudo label of the input image.

When the category probability in the global classification result is less than the preset threshold, the category probability is set to 0, and when the category probability in the global classification result is greater than or equal to the preset threshold, the category probability is set to 1, so that the binarization of the global classification result can be realized.

Understandably, if the global classification probability of a certain object category is small (that is, the category probability of the object category in the global classification result is small), it means that from the perspective of global information, the probability that the object category exists in the input image is small. If the detection head of the object detection model outputs a very high category probability for the object category, it means that the detection of the detection head is wrong, and this situation needs to be suppressed. The unreasonable classification result in the preselected pseudo label may be suppressed by the multiplication operation in the above example. For example, taking the elephant (representing a certain object category) in the above example as an example, when the classification result of the object in the detection box in the preselected pseudo label is expressed by the category probability, the classification result of the object in the detection box in the preselected pseudo label includes the category probability that the object is an elephant, the category probability is acquired by the object detection model based on the local features of the detection box, and the category probability of the elephant is very high (for example, 0.9). However, the category probability of elephants in the global classification result should be very low (for example, 0.01). This means that the object detection model is wrong in predicting elephants. Furthermore, after multiplying the category probability in the global classification result with the category probability that the object in the preselected pseudo label is an elephant, the new category probability that the object in the preselected pseudo label is an elephant is 0.009. In this way, the previous 0.9 is suppressed. Based on this, the quality of the preselected pseudo label may be improved, and further, the quality of the object pseudo label obtained by subsequent filtering may also be improved.

Based on the above, after adding the GCM module, the discriminative capability of the model may be enhanced by integrating global features, and the quality of the object pseudo label may also be improved at the same time, thus making the detection performance of the object detection model higher.

It may be seen that there may be domain differences between different datasets. For example, images in different datasets have different scenes, different perspectives, different styles and so on. Based on this, a Scene-Aware Fusion (SAF) module is added in the embodiments of the present disclosure to synthesize some images with low similarity in the multi-dataset into a new image, and the new image is used to train the auxiliary detection model to enhance the generalization ability of the auxiliary detection model to the domain.

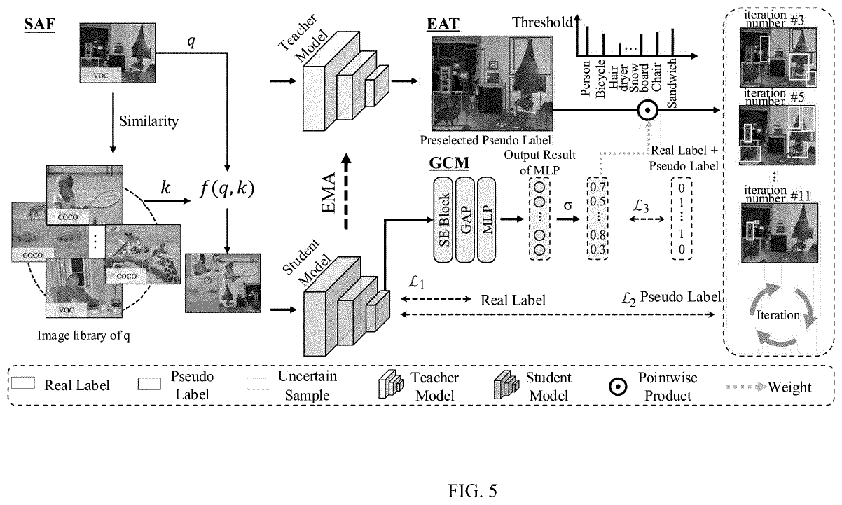

Referring to FIG. 4d and FIG. 5, FIG. 4d is a schematic diagram of another multi-dataset object detection method provided by at least one embodiment of the present disclosure, and FIG. 5 is a schematic diagram of another multi-dataset object detection method provided by at least one embodiment of the present disclosure. The SAF module will be described with reference to FIG. 4d and FIG. 5.

In one possible implementation, the embodiments of the present disclosure provide a specific implementation of determining the multi-object detection result of the input image based on the auxiliary detection model in S302, including:

C1: acquiring at least two datasets, in which real labels of images in different datasets correspond to different object categories.

As shown in FIG. 4a, dataset A and dataset B are taken as examples to explain. Alternatively, as shown in FIG. 5, VOC dataset (which may also be regarded as dataset A) and COCO dataset (which may also be regarded as dataset B) are taken as examples to explain.

The real labels of images in different datasets correspond to different object categories. For example, dataset A labels the real labels of object categories such as tree and television, while dataset B labels the real labels of object categories such as badminton racket, giraffe and zebra.

C2: determining any first image from the at least two datasets, and respectively calculating the similarity between the first image and any of the remaining images in the at least two datasets except the first image.

As shown in FIG. 5, the first image may be represented as an image q. Any of the remaining images in the at least two datasets except the first image may be represented as an image k.

As an optional example, a scene classification model may be pre-trained based on scene data, and the scene classification model obtained by training may be used to extract the feature vector of the image. Both the image q and the image k are input into the scene classification model, and the feature vectors of image q and image k are acquired. Then the cosine similarity between the feature vector of image q and the feature vector of image k is calculated.

In addition, other feature extraction models may be used, as long as the feature vector of the image can be extracted.

It may be understood that other methods may be used to calculate the similarity between the image q and any image k, which is not limited here.

C3: determining a preset number of second images satisfying a low similarity condition from the remaining images in the at least two datasets.

As an optional example, the low similarity condition is that a low similarity range is satisfied. It may be understood that the embodiments of the present disclosure do not limit the low similarity range, and may be determined according to the actual situation. The similarity between the second image and the first image satisfying the low similarity condition is low.

In concrete implementation, N second images satisfying the low similarity condition may be selected to form an image library of the first image. Furthermore, in the process of training the model, a preset number of second images are selected from the image library of the first image, and the preset number is less than or equal to N.

It may be understood that the embodiments of the present disclosure do not limit N and the preset number, which may be determined according to the actual situation. For example, N is 16, and the preset number is 3.

C4: synthesizing the first image and the preset number of second images to acquire a third image.

For example, a general image synthesis function f(q, k) may be used to synthesize the first image and the preset number of second images.

Specifically, first the first image and the preset number of second images are synthesized to acquire a synthesized image. Furthermore, the synthesized image is scaled to obtain the third image. The first image, the second image and the third image have the same size.

As an optional example, the synthesizing operation is a splicing operation. For example, when the preset number is three, the third image is obtained by splicing four images together, and the four images are located at the upper left corner, the upper right corner, the lower left corner and the lower right corner of the third image.

C5: determining the first image as the input image, and inputting the third image into the auxiliary detection model to acquire the multi-object detection result of the input image.

As an optional example, the usage probability of SAF may be set, and the usage probability of SAF may be different during each iteration of training the model.

When the usage probability of SAF is greater than a usage probability threshold (for example, 0.5), it means that in the process of training the auxiliary detection model, the SAF module will be used to input the third image into the auxiliary detection model. It may be understood that because the third image is synthesized from the first image and the preset number of second images, the third image may be regarded as including the first image. In addition, on the basis of inputting the third image into the auxiliary detection model, a separate first image may also be input into the auxiliary detection model.

The synthesized third image is also labeled with a real label, and the real label of the synthesized third image is composed of the real label of each image before synthesis.

In addition, when the usage probability of SAF is less than or equal to the usage probability threshold (for example, 0.5), it means that the SAF module is not used in the process of training the auxiliary detection model, and the image input into the auxiliary detection model is only a separate first image.

It may be understood that the distributions of images from different datasets are usually different and the similarity is low. Synthesizing multiple images with different distributions and low similarity, and then training the auxiliary detection model based on the synthesized images can make the auxiliary detection model forcibly learn the differences of the multiple images, learn the distribution features of different datasets, alleviate the performance degradation of the auxiliary detection model caused by domain differences, and further enhance the generalization ability of the auxiliary detection model to images in different domains, and also improve the generalization ability of the object detection model to images in different domains. In addition, it can optimize the quality of the object pseudo label and improve the detection performance of the object detection model.

The embodiments of the present disclosure may add one or more of the EAT module, the GCM module, and the SAF model to the model structure shown in FIG. 4a. By adding the EAT module, the GCM module and/or the SAF model, the auxiliary detection model may learn better features, and then have stronger detection performance, which makes the detection performance of the object detection model higher. As shown in FIG. 5, with the training of the auxiliary detection model, the object pseudo label is constantly iterating, such as the object pseudo labels with iteration number #3, iteration number #5 . . . iteration number #11. With the improvement of the quality of the object pseudo label, the training performance of the auxiliary detection model is getting better and better. In this way, the object detection model with higher detection performance can be obtained.

Understandably, when labeling a dataset with real labels, only half of the images or full images in the dataset may be labeled, and the model training effect under the condition of missing half of image labeling is similar to the model training effect under the condition of full image labeling, which means that only half of the images need to be labeled. In this way, the cost of labeling may also be greatly reduced.

The present disclosure may be further combined to provide more implementations on the basis of the implementations provided by the above aspects.

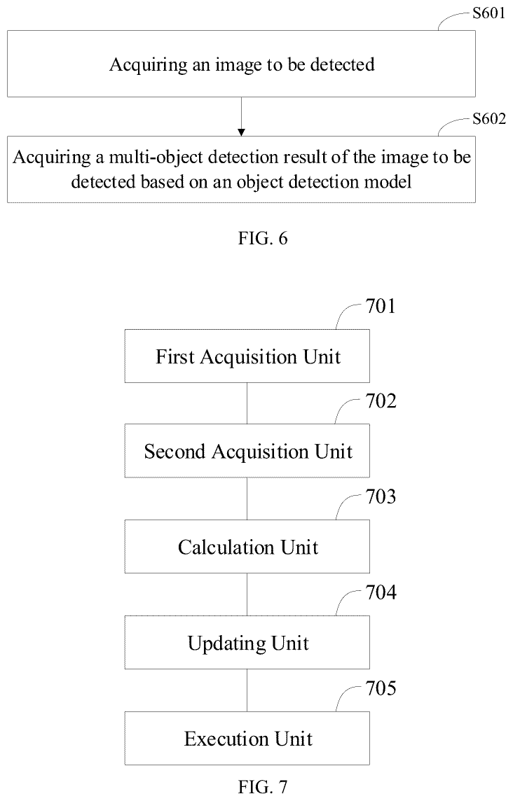

Based on the training method of the object detection model provided by the above method embodiment, after the object detection model is obtained, multi-object detection of the image to be detected may be realized based on the object detection model. Referring to FIG. 6, FIG. 6 is a flowchart of an object detection method provided by at least one embodiment of the present disclosure. As shown in FIG. 6, the method may include the following steps:

S601: acquiring an image to be detected;

S602: acquiring a multi-object detection result of the image to be detected based on an object detection model.

The object detection model is obtained by training according to the training method of the object detection model described in any of the above embodiments.

It may be understood that the multi-object detection result includes detection results of multiple categories of objects. The detection result includes the coordinate information of the detection box and the object category.

Based on the related contents of S601-S602, it may be known that the object in the image to be detected may be better detected through the obtained object detection model, and the detection result with high accuracy may be obtained, which meets the detection requirements.

It may be understood by those skilled in the art that in the above-mentioned methods of specific embodiments, the writing order of each step does not mean strict execution order and constitutes any limitation on the implementation process, and the specific execution order of each step should be determined according to its function and possible internal logic.

Based on the training method of the object detection model provided by the above method embodiments, the embodiments of the present disclosure further provide a training apparatus of an object detection model, and the training apparatus of the object detection model will be described with the drawings. Because the principle of solving problems by the apparatus in the embodiments of the present disclosure is similar to the above-mentioned training method of the object detection model in the embodiments of the present disclosure, the implementation of the apparatus may refer to the implementation of the method, and the repetition will not be repeated here.

Referring to FIG. 7, which is a schematic structural diagram of a training apparatus of an object detection model provided by at least one embodiment of the present disclosure. As shown in FIG. 7, the training apparatus of the object detection model includes:
a first acquisition unit 701, configured to acquire an input image and determine an object pseudo label of the input image based on an object detection model, in which the input image is labeled with a real label;
a second acquisition unit 702, configured to acquire a multi-object detection result of the input image based on an auxiliary detection model;
a calculation unit 703, configured to calculate a first loss according to the multi-object detection result of the input image and the real label of the input image, and calculate a second loss according to the multi-object detection result of the input image and the object pseudo label of the input image;
an updating unit 704, configured to update the auxiliary detection model according to the first loss and the second loss, and update the object detection model based on the auxiliary detection model that has been updated;
and an execution unit 705, configured to continuously execute the acquiring the input image, determining the object pseudo label of the input image based on the object detection model, and subsequent steps until a preset condition is reached.

Optionally, the first acquisition unit 701 includes:
a first determination subunit, configured to determine a preselected pseudo label of the input image based on the object detection model, in which the preselected pseudo label corresponds to a detection box confidence;
a second determination subunit, configured to determine a first confidence threshold corresponding to each object category in the input image;
and a third determination subunit, configured to, in response to the detection box confidence corresponding to the preselected pseudo label being greater than a first confidence threshold of a corresponding object category, retain the preselected pseudo label, and determine the object pseudo label of the input image.

Optionally, the apparatus further includes:
a first determination unit, configured to determine a second confidence threshold corresponding to each object category in the input image, in which the second confidence threshold is less than the first confidence threshold of the same object category;
a second determination unit, configured to, in response to the detection box confidence corresponding to the preselected pseudo label being greater than or equal to a second confidence threshold of a corresponding object category and less than or equal to the first confidence threshold of the same object category, take the preselected pseudo label as an uncertain pseudo label;
and a third determination unit, configured to, in response to the detection box confidence corresponding to the preselected pseudo label being less than the second confidence threshold corresponding to each object category, take the preselected pseudo label as a background pseudo label.

Optionally, the preselected pseudo label includes a first preselected pseudo label and a second preselected pseudo label; an object category corresponding to the first preselected pseudo label belongs to a first category, and an object category corresponding to the second preselected pseudo label belongs to a second category; a sample proportion of the first category is greater than a sample proportion of the second category;
and a first confidence threshold of the object category corresponding to the first preselected pseudo label is greater than a first confidence threshold of the object category corresponding to the second preselected pseudo label.

Optionally, the second determination subunit includes:
a first calculation subunit, configured to calculate an entropy of the preselected pseudo label of the input image;
a second calculation subunit, configured to calculate an average entropy of each object category in the input image according to the entropy of the preselected pseudo label;
and a third calculation subunit, configured to calculate the first confidence threshold corresponding to each object category in the input image according to the average entropy of each object category in the input image.

Optionally, the auxiliary detection model includes a feature extraction network, and the apparatus further includes:
a third acquisition unit, configured to acquire a feature map of the input image extracted by the feature extraction network;
a fourth acquisition unit, configured to input the feature map into a global classification module to acquire a global classification result of the input image;
a fifth acquisition unit, configured to acquire a third loss according to the global classification result and a global classification label;
and the updating unit is specifically configured to:
update the auxiliary detection model according to the first loss, the second loss and the third loss.

Optionally, the apparatus further includes:
an adjustment unit, configured to adjust the preselected pseudo label of the input image based on the global classification result after determining the preselected pseudo label of the input image and before determining the first confidence threshold corresponding to each object category in the input image.

Optionally, the global classification module includes a global feature extraction module;
the fourth acquisition unit includes:
a first acquisition subunit, configured to input the feature map into the global feature extraction module to acquire an output feature map, in which the output feature map is used to represent global information of the input image;
and a second acquisition subunit, configured to acquire the global classification result of the input image based on the output feature map.

Optionally, the second acquisition unit 702 includes:
a third acquisition subunit, configured to acquire at least two datasets, in which real labels of images in different datasets correspond to different object categories;
a fourth calculation subunit, configured to determine any first image from the at least two datasets, and respectively calculate a similarity between the first image and any of remaining images in the at least two datasets except the first image;
a fourth determination subunit, configured to determine a preset number of second images satisfying a low similarity condition from the remaining images in the at least two datasets;
a synthesis subunit, configured to synthesize the first image and the preset number of second images to acquire a third image;
and a fifth determination subunit, configured to determine the first image as the input image, and input the third image into the auxiliary detection model to acquire the multi-object detection result of the input image.

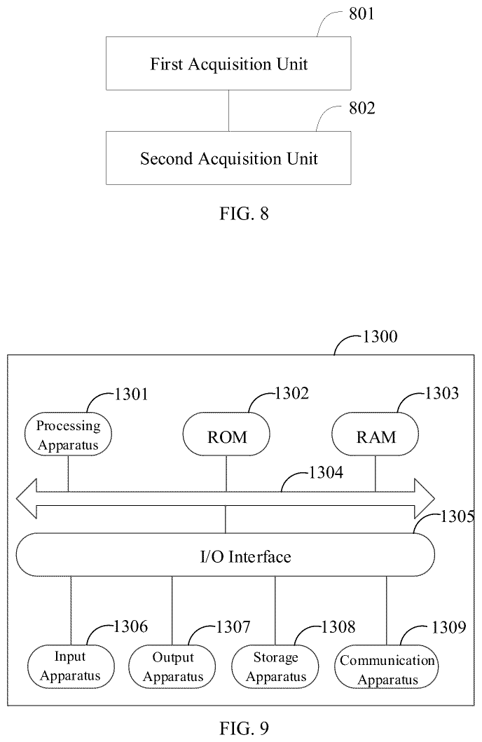

Referring to FIG. 8, which is a structural schematic diagram of an object detection apparatus provided by at least one embodiment of the present disclosure. As shown in FIG. 8, the object detection apparatus includes:
a first acquisition unit 801, configured to acquire an image to be detected;
a second acquisition unit 802, configured to acquire a multi-object detection result of the image to be detected based on the object detection model;
and the object detection model is acquired by training according to any training method of the object detection model.

Based on the training method of the object detection model and the object detection method provided by the above method embodiments, the disclosure further provides an electronic device, including: one or more processors; and a storage apparatus on which one or more programs are stored; the one or more programs, when executed by the one or more processors, enable the one or more processors to implement the training method of the object detection model described in any of the above embodiments, or the object detection method described in any of the above embodiments.

Referring to FIG. 9, FIG. 9 illustrates a schematic structural diagram of an electronic device 1300 suitable for implementing the embodiments of the present disclosure. The electronic devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 1300 may include a processing apparatus 1301 (e.g., a central processing unit, a graphics processing unit, etc.), which can perform various suitable actions and processing according to a program stored in a read-only memory (ROM) 1302 or a program loaded from a storage apparatus 1308 into a random-access memory (RAM) 1303. The RAM 1303 further stores various programs and data required for operations of the electronic device 1300. The processing apparatus 1301, the ROM 1302, and the RAM 1303 are interconnected through a bus 1304. An input/output (I/O) interface 1305 is also connected to the bus 1304.

Usually, the following apparatuses may be connected to the I/O interface 1305: an input apparatus 1306 including, for example, a touch screen, a touch pad, a keyboard, a mouse, a camera, a microphone, an accelerometer, a gyroscope, or the like; an output apparatus 1307 including, for example, a liquid crystal display (LCD), a loudspeaker, a vibrator, or the like; a storage apparatus 1308 including, for example, a magnetic tape, a hard disk, or the like; and a communication apparatus 1309. The communication apparatus 1309 may allow the electronic device 1300 to be in wireless or wired communication with other devices to exchange data. While FIG. 9 illustrates the electronic device 1300 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 1309 and installed, or may be installed from the storage apparatus 1308, or may be installed from the ROM 1302. When the computer program is executed by the processing apparatus 1301, the above-mentioned functions defined in the methods of some embodiments of the present disclosure are performed.

The electronic device provided by the embodiments of the present disclosure belongs to the same inventive concept as the training method of the object detection model and the object detection method provided by the above-mentioned embodiments, and technical details not exhaustively described in the present embodiment may be referred to the above embodiments, and the present embodiment has the same beneficial effects as the above embodiments.

Based on the training method of the object detection model and the object detection method provided by the above method embodiments, the embodiments of the present disclosure provide a computer-readable medium on which a computer program is stored, and the computer program, when executed by a processor, implements the training method of the object detection model or the object detection method described in any of the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to implement the training method of the object detection model or the object detection method.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides a training method of an object detection model, which includes:
acquiring an input image, and determining an object pseudo label of the input image based on an object detection model, in which the input image is labeled with a real label;
acquiring a multi-object detection result of the input image based on an auxiliary detection model;
calculating a first loss according to the multi-object detection result of the input image and the real label of the input image, and calculating a second loss according to the multi-object detection result of the input image and the object pseudo label of the input image;
updating the auxiliary detection model according to the first loss and the second loss, and updating the object detection model based on the auxiliary detection model that has been updated;
and continuously executing the acquiring the input image, determining the object pseudo label of the input image based on the object detection model, and subsequent steps until a preset condition is reached.

According to one or more embodiments of the present disclosure, Example 2 provides the training method of the object detection model, and determining the object pseudo label of the input image based on the object detection model includes:
determining a preselected pseudo label of the input image based on the object detection model, in which the preselected pseudo label corresponds to a detection box confidence;
determining a first confidence threshold corresponding to each object category in the input image;
and in response to the detection box confidence corresponding to the preselected pseudo label being greater than a first confidence threshold of a corresponding object category, retaining the preselected pseudo label, and determining the object pseudo label of the input image.

According to one or more embodiments of the present disclosure, Example 3 provides the training method of the object detection model, which further includes:
determining a second confidence threshold corresponding to each object category in the input image, in which the second confidence threshold is less than the first confidence threshold of the same object category;
in response to the detection box confidence corresponding to the preselected pseudo label being greater than or equal to a second confidence threshold of a corresponding object category and less than or equal to the first confidence threshold of the same object category, taking the preselected pseudo label as an uncertain pseudo label;
and in response to the detection box confidence corresponding to the preselected pseudo label being less than the second confidence threshold corresponding to each object category, taking the preselected pseudo label as a background pseudo label.

According to one or more embodiments of the present disclosure, Example 4 provides the training method of the object detection model, the preselected pseudo label includes a first preselected pseudo label and a second preselected pseudo label; an object category corresponding to the first preselected pseudo label belongs to a first category, and an object category corresponding to the second preselected pseudo label belongs to a second category; a sample proportion of the first category is greater than a sample proportion of the second category;
and a first confidence threshold of the object category corresponding to the first preselected pseudo label is greater than a first confidence threshold of the object category corresponding to the second preselected pseudo label.

According to one or more embodiments of the present disclosure, Example 5 provides the training method of the object detection model, and determining the first confidence threshold corresponding to each object category in the input image includes:
calculating an entropy of the preselected pseudo label of the input image;
calculating an average entropy of each object category in the input image according to the entropy of the preselected pseudo label;
and calculating the first confidence threshold corresponding to each object category in the input image according to the average entropy of each object category in the input image.

According to one or more embodiments of the present disclosure, Example 6 provides the training method of the object detection model, the auxiliary detection model includes a feature extraction network, and the method further includes:
acquiring a feature map of the input image extracted by the feature extraction network;
inputting the feature map into a global classification module to acquire a global classification result of the input image;
and acquiring a third loss according to the global classification result and a global classification label;
and updating the auxiliary detection model according to the first loss and the second loss includes:
updating the auxiliary detection model according to the first loss, the second loss and the third loss.

According to one or more embodiments of the present disclosure, Example 7 provides the training method of the object detection model, after determining the preselected pseudo label of the input image and before determining the first confidence threshold corresponding to each object category in the input image, the method further includes:
adjusting the preselected pseudo label of the input image based on the global classification result.

According to one or more embodiments of the present disclosure, Example 8 provides the training method of the object detection model, and the global classification module includes a global feature extraction module;
and inputting the feature map into the global classification module to acquire the global classification result of the input image includes:
inputting the feature map into the global feature extraction module to acquire an output feature map, in which the output feature map is used to represent global information of the input image;
and acquiring the global classification result of the input image based on the output feature map.

According to one or more embodiments of the present disclosure, Example 9 provides the training method of the object detection model, and acquiring the multi-object detection result of the input image based on the auxiliary detection model includes:
acquiring at least two datasets, wherein real labels of images in different datasets correspond to different object categories;
determining any first image from the at least two datasets, and respectively calculating a similarity between the first image and any of remaining images in the at least two datasets except the first image;
determining a preset number of second images satisfying a low similarity condition from the remaining images in the at least two datasets;
synthesizing the first image and the preset number of second images to acquire a third image;
and determining the first image as the input image, and inputting the third image into the auxiliary detection model to acquire the multi-object detection result of the input image.

According to one or more embodiments of the present disclosure, Example 10 provides an object detection method, which includes:
acquiring an image to be detected;
acquiring a multi-object detection result of the image to be detected based on an object detection model;
and the object detection model is acquired according to any training method of the object detection model.

It should be noted that the various embodiments in the present disclosure are described in a progressive manner, with each embodiment focusing on the differences from other embodiments, and similar parts between the various embodiments may be referred to each other. For the systems or apparatuses disclosed in the embodiments, because they correspond to the methods disclosed in the embodiments, the description is relatively simple, and the relevant parts may refer to the description of the methods for details.

It should be understood that, in the present disclosure, “at least one (item)” refers to one or more, and “a plurality of” refers to two or more. “And/or” is used to describe the association relationship between associated objects, indicating that there may be three relationships. For example, “A and/or B” may indicate: only A exists, only B exists, and both A and B exist simultaneously, where A, B may be singular or plural. The character “/” generally indicates that the associated objects before and after are in a kind of “or” relationship. “At least one (item)” or similar expressions refer to any combination of these items, including any combination of single (item) or multiple (items). For example, at least one (item) of a, b, or c may indicate: a, b, c, “a and b”, “a and c”, “b and c”, or “a, b, and c”, where a, b, and c may be singular or plural.

It should be noted that in the present disclosure, relational terms such as “first,” “second,” etc. are only used to distinguish one entity or operation from another entity or operation, and do not necessarily require or imply the existence of any actual relationship or order between these entities or operations. Furthermore, the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The steps of the methods or algorithms described in the embodiments of the present disclosure may be implemented directly with hardware, software modules executed by a processor, or a combination of both. The software modules may be placed in random access memory (RAM), memory, read-only memory (ROM), electrically programmable ROM, electrically erasable programmable ROM, registers, hard disks, removable disks, CD-ROMs, or any other form of storage medium known in the art.

The above-mentioned description of the disclosed embodiments enables those skilled in the art to implement or use the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments described herein but is to be accorded the widest scope consistent with the principles and novel features disclosed herein.

1. A training method of an object detection model, comprising:
acquiring an input image, and determining an object pseudo label of the input image based on an object detection model, wherein the input image is labeled with a real label;
acquiring a multi-object detection result of the input image based on an auxiliary detection model;
calculating a first loss according to the multi-object detection result of the input image and the real label of the input image, and calculating a second loss according to the multi-object detection result of the input image and the object pseudo label of the input image; and
updating the auxiliary detection model according to the first loss and the second loss, and updating the object detection model based on the auxiliary detection model that has been updated.

2. The method according to claim 1, wherein the determining the object pseudo label of the input image based on the object detection model comprises:
determining a preselected pseudo label of the input image based on the object detection model, wherein the preselected pseudo label corresponds to a detection box confidence;
determining a first confidence threshold corresponding to each object category in the input image; and
in response to the detection box confidence corresponding to the preselected pseudo label being greater than a first confidence threshold of a corresponding object category, retaining the preselected pseudo label, and determining the object pseudo label of the input image.

3. The method according to claim 2, further comprising:
determining a second confidence threshold corresponding to each object category in the input image, wherein the second confidence threshold is less than the first confidence threshold of the same object category;
in response to the detection box confidence corresponding to the preselected pseudo label being greater than or equal to a second confidence threshold of a corresponding object category and less than or equal to the first confidence threshold of the same object category, taking the preselected pseudo label as an uncertain pseudo label; and
in response to the detection box confidence corresponding to the preselected pseudo label being less than the second confidence threshold corresponding to each object category, taking the preselected pseudo label as a background pseudo label.

4. The method according to claim 2, wherein the preselected pseudo label comprises:
a first preselected pseudo label and a second preselected pseudo label;
an object category corresponding to the first preselected pseudo label belongs to a first category, and an object category corresponding to the second preselected pseudo label belongs to a second category;
a sample proportion of the first category is greater than a sample proportion of the second category; and
a first confidence threshold of the object category corresponding to the first preselected pseudo label is greater than a first confidence threshold of the object category corresponding to the second preselected pseudo label.

5. The method according to claim 2, wherein the determining the first confidence threshold corresponding to each object category in the input image comprises:
calculating an entropy of the preselected pseudo label of the input image;
calculating an average entropy of each object category in the input image according to the entropy of the preselected pseudo label; and
calculating the first confidence threshold corresponding to each object category in the input image according to the average entropy of each object category in the input image.

6. The method according to claim 2, wherein the auxiliary detection model comprises a feature extraction network, and the method further comprises:
acquiring a feature map of the input image extracted by the feature extraction network;
inputting the feature map into a global classification module to acquire a global classification result of the input image; and
acquiring a third loss according to the global classification result and a global classification label; and
the updating the auxiliary detection model according to the first loss and the second loss comprises:
updating the auxiliary detection model according to the first loss, the second loss and the third loss.

7. The method according to claim 6, wherein after determining the preselected pseudo label of the input image and before determining the first confidence threshold corresponding to each object category in the input image, the method further comprises:
adjusting the preselected pseudo label of the input image based on the global classification result.

8. The method according to claim 6, wherein the global classification module comprises:
a global feature extraction module;
the inputting the feature map into the global classification module to acquire the global classification result of the input image comprises:
inputting the feature map into the global feature extraction module to acquire an output feature map, wherein the output feature map is used to represent global information of the input image; and
acquiring the global classification result of the input image based on the output feature map.

9. The method according to claim 1, wherein acquiring the multi-object detection result of the input image based on the auxiliary detection model comprises:
acquiring at least two datasets, wherein real labels of images in different datasets correspond to different object categories;
determining any first image from the at least two datasets, and respectively calculating a similarity between the first image and any of remaining images in the at least two datasets except the first image;
determining a preset number of second images satisfying a low similarity condition from the remaining images in the at least two datasets;
synthesizing the first image and the preset number of second images to acquire a third image; and
determining the first image as the input image, and inputting the third image into the auxiliary detection model to acquire the multi-object detection result of the input image.

10. An electronic device, comprising:
one or more processors; and
a storage apparatus on which one or more programs are stored,
wherein the one or more programs, when executed by the one or more processors, enable the one or more processors to implement a training method of an object detection model, and the training method of an object detection model comprises:
acquiring an input image, and determining an object pseudo label of the input image based on an object detection model, wherein the input image is labeled with a real label;
acquiring a multi-object detection result of the input image based on an auxiliary detection model;
calculating a first loss according to the multi-object detection result of the input image and the real label of the input image, and calculating a second loss according to the multi-object detection result of the input image and the object pseudo label of the input image; and
updating the auxiliary detection model according to the first loss and the second loss, and updating the object detection model based on the auxiliary detection model that has been updated.

11. The electronic device according to claim 10, wherein the determining the object pseudo label of the input image based on the object detection model comprises:
determining a preselected pseudo label of the input image based on the object detection model, wherein the preselected pseudo label corresponds to a detection box confidence;
determining a first confidence threshold corresponding to each object category in the input image; and
in response to the detection box confidence corresponding to the preselected pseudo label being greater than a first confidence threshold of a corresponding object category, retaining the preselected pseudo label, and determining the object pseudo label of the input image.

12. The electronic device according to claim 11, wherein the training method of an object detection model further comprises:
determining a second confidence threshold corresponding to each object category in the input image, wherein the second confidence threshold is less than the first confidence threshold of the same object category;
in response to the detection box confidence corresponding to the preselected pseudo label being greater than or equal to a second confidence threshold of a corresponding object category and less than or equal to the first confidence threshold of the same object category, taking the preselected pseudo label as an uncertain pseudo label; and
in response to the detection box confidence corresponding to the preselected pseudo label being less than the second confidence threshold corresponding to each object category, taking the preselected pseudo label as a background pseudo label.

13. The electronic device according to claim 11, wherein the preselected pseudo label comprises a first preselected pseudo label and a second preselected pseudo label;
an object category corresponding to the first preselected pseudo label belongs to a first category, and an object category corresponding to the second preselected pseudo label belongs to a second category;
a sample proportion of the first category is greater than a sample proportion of the second category; and
a first confidence threshold of the object category corresponding to the first preselected pseudo label is greater than a first confidence threshold of the object category corresponding to the second preselected pseudo label.

14. The electronic device according to claim 11, wherein the determining the first confidence threshold corresponding to each object category in the input image comprises:
calculating an entropy of the preselected pseudo label of the input image;
calculating an average entropy of each object category in the input image according to the entropy of the preselected pseudo label; and
calculating the first confidence threshold corresponding to each object category in the input image according to the average entropy of each object category in the input image.

15. A computer-readable storage medium on which a computer program is stored, wherein the computer program, when executed by a processor, causes the process to perform operations comprising:
acquiring an input image, and determining an object pseudo label of the input image based on an object detection model, wherein the input image is labeled with a real label;
acquiring a multi-object detection result of the input image based on an auxiliary detection model;
calculating a first loss according to the multi-object detection result of the input image and the real label of the input image, and calculating a second loss according to the multi-object detection result of the input image and the object pseudo label of the input image; and
updating the auxiliary detection model according to the first loss and the second loss, and updating the object detection model based on the auxiliary detection model that has been updated.

16. The computer-readable storage medium of claim 15, wherein the determining the object pseudo label of the input image based on the object detection model comprises:
determining a preselected pseudo label of the input image based on the object detection model, wherein the preselected pseudo label corresponds to a detection box confidence;
determining a first confidence threshold corresponding to each object category in the input image; and
in response to the detection box confidence corresponding to the preselected pseudo label being greater than a first confidence threshold of a corresponding object category, retaining the preselected pseudo label, and determining the object pseudo label of the input image.

17. The computer-readable storage medium of claim 16, the operations further comprising:
determining a second confidence threshold corresponding to each object category in the input image, wherein the second confidence threshold is less than the first confidence threshold of the same object category;
in response to the detection box confidence corresponding to the preselected pseudo label being greater than or equal to a second confidence threshold of a corresponding object category and less than or equal to the first confidence threshold of the same object category, taking the preselected pseudo label as an uncertain pseudo label; and
in response to the detection box confidence corresponding to the preselected pseudo label being less than the second confidence threshold corresponding to each object category, taking the preselected pseudo label as a background pseudo label.

18. The computer-readable storage medium of claim 16, wherein the preselected pseudo label comprises a first preselected pseudo label and a second preselected pseudo label;
an object category corresponding to the first preselected pseudo label belongs to a first category, and an object category corresponding to the second preselected pseudo label belongs to a second category;
a sample proportion of the first category is greater than a sample proportion of the second category; and
a first confidence threshold of the object category corresponding to the first preselected pseudo label is greater than a first confidence threshold of the object category corresponding to the second preselected pseudo label.

19. The computer-readable storage medium of claim 16, wherein the determining the first confidence threshold corresponding to each object category in the input image comprises:
calculating an entropy of the preselected pseudo label of the input image;
calculating an average entropy of each object category in the input image according to the entropy of the preselected pseudo label; and
calculating the first confidence threshold corresponding to each object category in the input image according to the average entropy of each object category in the input image.

20. The computer-readable storage medium of claim 16, wherein the auxiliary detection model comprises a feature extraction network, and the operations further comprise:
acquiring a feature map of the input image extracted by the feature extraction network;
inputting the feature map into a global classification module to acquire a global classification result of the input image; and
acquiring a third loss according to the global classification result and a global classification label; and
the updating the auxiliary detection model according to the first loss and the second loss comprises:
updating the auxiliary detection model according to the first loss, the second loss and the third loss.
